(19) United States
(12) Patent Application Publication
(10) Pub. No.: US 2009/0095123 A1
(43) Pub. Date: Apr. 16, 2009

(54) Anatomically supportive pedal platform

(76) Inventor: David Weagle, Edgartown, MA (US)

Correspondence Address: STAHL LAW FIRM, 2 MEADOWSWEET LANE, SAN CARLOS, CA, 94070, US

(21) Appl. No.: 12/229,610

(22) Filed: Aug. 23, 2008

Related U.S. Application Data
(63) Continuation-in-part of application No. 11/973,873, filed on Oct. 10, 2007.

(51) Int. Cl. G05G 1/30

(52) U.S. Cl. 74/560

(57) ABSTRACT

This invention relates to pedals for use on vehicles, especially bicycles. A pedal of the invention comprises an anatomically supportive shape. A pedal according to certain embodiments comprises an upper and a lower footbed portion. In certain other embodiments, a pedal comprises one or more barrier portions.

This application is a continuation-in-part of U.S. application Ser. No. 11/973,873 filed Oct. 10, 2007, currently pending, which is incorporated herein by reference.

### 1.0 FIELD OF THE INVENTION

This invention relates to bicycle pedals and specifically anatomically supportive pedal platforms.

### 2.0 BACKGROUND

Various vehicles, like bicycles, use force applied to pedals to drive the vehicles. On these vehicles, pedals are pushed or pulled by a rider's feet and attached to a crank arm mechanism that transforms force at the pedals into rotary motion. This rotary motion is transmitted through a power transmission system to a wheel or wheels, which transfers rotary motion to the ground via tractive force between a wheel or wheels and the ground. Vehicles are also used to traverse even terrain like paved streets, and uneven terrain like off-road dirt trails. Off road trails are generally bumpier and have obstacles such as fallen trees, rocks, and mud. BMX style trick riding is a popular activity on paved streets and in bike parks built for that purpose. Obstacles like paved curbs, stone architectural details, wood benches, and metal rails are commonly found in the street and bike park environments. Because of a bicycle pedal's location close to the ground, impacts with these obstacles are common. Impact between a pedal and an obstacle typically can result in a rider's foot being forced out of contact with the pedal platform surface. During BMX style trick riding a rider can intentionally remove his or her foot from the pedal platform surface momentarily while jumping the bike in the air as part of a trick. Accurate placement of the foot on the pedal platform surface after it has been removed is of paramount importance. This lack of contact between the pedal and foot can pose a safety hazard to both the rider and bystanders.

A need exists for a bicycle pedal that can help a rider to more easily feel the pedal with his or her foot and locate the foot accurately and quickly in relation to the pedal. The present invention provides new designs for bicycle pedals that can help a rider to more easily feel the pedal platform with his or her foot and locate the foot accurately and quickly in relation to the pedal.

### 3.0 SUMMARY OF THE INVENTION

The current invention relates to new pedal designs for bicycles. In certain embodiments of the invention, a pedal of the invention can comprise a body, a platform, and a pin, whereby a platform is designed to be anatomically supportive of a foot. In certain embodiments, platforms are separate parts from a body, and are attached to a body by pins. In certain embodiments, platforms and a body are combined, and manufactured as a singular part. In certain embodiments, an anatomically supportive platform can be designed to work with non-clipless type shoes. In certain embodiments, an anatomically supportive platform can be designed to work with cycling clip-in shoes. In certain other embodiments, an anatomically supportive platform has one or more dimensions adjusted to be more suited with a shoe of a size of interest or with shoes of two sizes of interest.

### 4.0 BRIEF DESCRIPTION OF THE DRAWINGS

FIG. 1A shows an exploded view of a pedal using an anatomically supportive platform according to certain embodiments of the current invention.

FIG. 1B shows an exploded view of a pedal using an anatomically supportive platform according to certain embodiments of the current invention.

FIG. 2 shows a top view of a pedal using an anatomically supportive platform according to certain embodiments of the current invention.

FIG. 3 shows a top view of a pedal using an anatomically supportive platform according to certain embodiments of the current invention.

FIG. 4 shows a top view of a pedal using an anatomically supportive platform according to certain embodiments of the current invention.

FIG. 5 shows a top view of a pedal using an anatomically supportive platform according to certain embodiments of the current invention.

FIG. 6A shows a sectional view A-A for FIGS. 2 and 4 of an anatomically supportive platform of a pedal according to certain embodiments of the current invention.

FIG. 6B shows a sectional view B-B for FIGS. 2 and 4 of an anatomically supportive platform of a pedal according to certain embodiments of the current invention.

### 5.0 DETAILED DESCRIPTION

The current invention relates to new pedal designs for bicycles. In certain embodiments of the invention, a pedal of the invention comprises a body, a platform, and a pin, wherein a platform is designed to be part of the body or a platform is removable and/or replaceable. In certain embodiments, a platform is a separate part from a body, and is attached to a body by pins. In certain embodiments, a platform can be designed to work with non-clipless type shoes. In certain embodiments, platforms can be designed to work with cycling clip in shoes. In certain embodiments, a platform can be designed to be most compatible with shoes of a type and/or size of interest. In certain embodiments, a pedal of the invention may have two platforms that are most compatible with shoes of different types and/or sizes of interest. In certain embodiments, a platform of a pedal of the invention is designed to favor a position that is lower (closer to the ground) than another platform of the pedal, preferably so that one side of the pedal is more favored to be up and therefore better accessible to the rider. In certain embodiments, pins can be threaded into a body. In certain embodiments, pins can secure a platform to a body by compressing a platform between a head of a pin and a body. In certain embodiments, a pin can comprise a shoulder, a head, and a traction spike. In certain embodiments, a shoulder can be a locating feature. In certain embodiments, a shoulder can be part of a body.

### 5.1 The Drawings Illustrative Examples of Certain Embodiments of the Invention

The Figures in this disclosure use the following numbers and terms; body (1); spindle (2); platform (3); pin (4); first barrier portion (5); second barrier portion (6); third barrier portion (7); section line A-A (8); section line B-B (9); hole (10); lower footbed distance (11); upper footbed distance (12); barrier portion angle (13); second angle (14); outer lower footbed distance (15); outer upper footbed distance (16); outer barrier portion angle (17); barrier portion edge (18); outer edge (19); barrier portion height (20); barrier portion width (21).

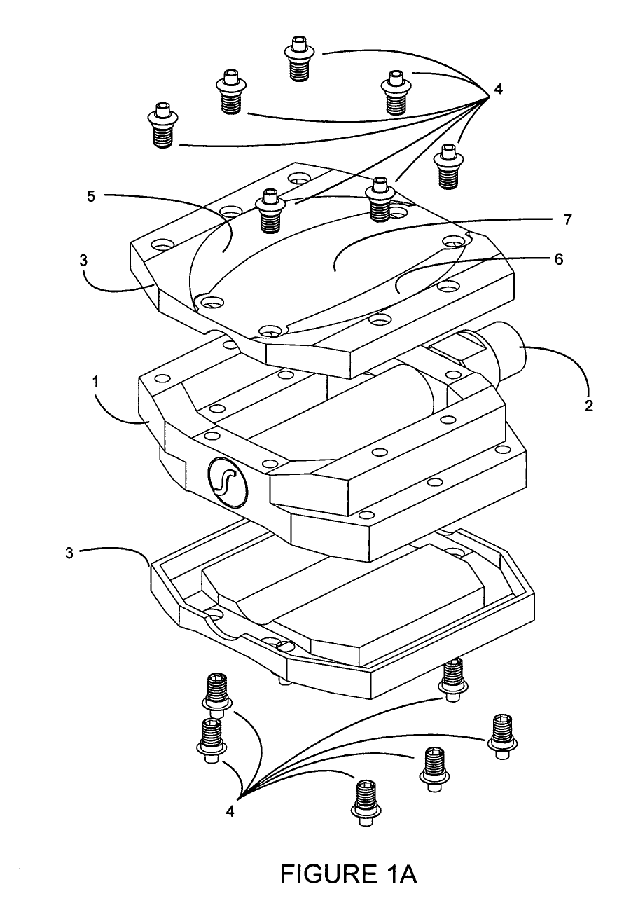

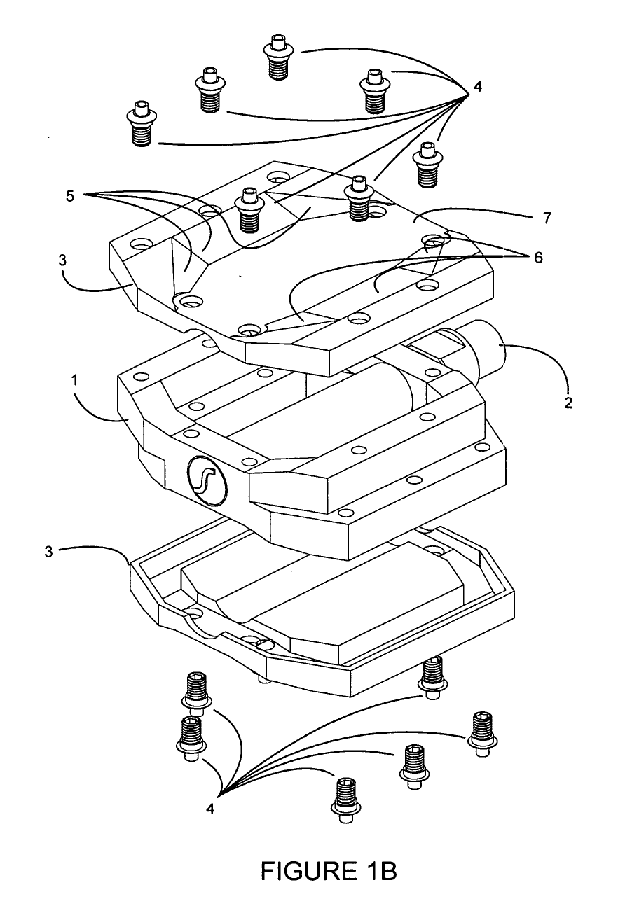

FIG. 1A presents a design for a pedal according to certain embodiments of the current invention via an exploded view. Shown in FIG. 1A are the following: body (1); spindle (2); platform (3); pin (4); first barrier portion (5); second barrier portion (6); third barrier portion (7). A body 1 acts as a structural support for platforms 3, and provides mounting features for pins 4. The body 1 includes a spindle 2, which is intended to be used to couple the pedal to a bicycle crank arm. The spindle 2 can be a replaceable item, separate from the body 1, or part of the body 1. In designs where a spindle 2 is replaceable, the body 1 can be attached to the spindle 2 so as to allow for independent rotation of the body in relation to the spindle 2. In designs where a spindle 2 is replaceable, the spindle 2 can use a threaded boss to mount to a tapped hole in a bicycle crank arm. In designs where a spindle 2 is part of the body 1, or fixedly attached to the body 1, a spindle 2 can use either a threaded boss or non-threaded boss to mount said spindle 2 to bearings in a bicycle crank arm. The pins 4 use threads that mate with mounting features in the body 1. Pins 4 are arranged so that each pin 4 is removable using a pin removal tool, and so that the pin's 4 tool engagement is protected inside the body 1 during impact. This allows for easier pin 4 and platform 3 removal. Identical platforms 3 can be used on two sides of the pedal to save cost. Platforms 3 can be a part of a body 1, where the platforms 3 and body 1 are manufactured as a continuous part. Platforms 3 can comprise a first barrier portion 5, a second barrier portion 6, and a third barrier portion 7. A first barrier portion 5 can be a surface that curves to help impede a rider's foot from moving in two or more directions when pressure is applied to the pedal. A second barrier portion 6 can be a surface that curves to help impede a rider's foot from moving in two or more directions when pressure is applied to the pedal. A third barrier portion 7 can be a surface that supports a foot to help impede a rider's foot from moving in one or more directions when pressure is applied to the pedal. A first barrier portion 5, second barrier portion 6, and third barrier portion 7 can form a barrier that defines an area where a rider's foot will be most comfortable on the pedal. This barrier can be felt by the rider's foot with little pressure, and can aid the rider in placing the foot by feel in a prescribed anatomical position and in relation to the pedal without the rider looking at the pedal.

FIG. 1B presents a design for a pedal according to certain embodiments of the current invention via an exploded view. Shown in FIG. 1B are the following: body (1); spindle (2); platform (3); pin (4); first barrier portion (5); second barrier portion (6); third barrier portion (7). A body 1 acts as a structural support for platforms 3, and provides mounting features for pins 4. The body 1 includes a spindle 2, which is intended to be used to couple the pedal to a bicycle crank arm. The spindle 2 can be a replaceable item, separate from the body 1, or part of the body 1. In designs where a spindle 2 is replaceable, the body 1 can be attached to the spindle 2 so as to allow for independent rotation of the body in relation to the spindle 2. In designs where a spindle 2 is replaceable, the spindle 2 can use a threaded boss to mount to a tapped hole in a bicycle crank arm. In designs where a spindle 2 is part of the body 1, or fixedly attached to the body 1, a spindle 2 can use either a threaded boss or non-threaded boss to mount said spindle 2 to bearings in a bicycle crank arm. The pins 4 use threads that mate with mounting features in the body 1. Pins 4 are arranged so that each pin 4 is removable using a pin removal tool, and so that the pin's 4 tool engagement is protected inside the body 1 during impact. This allows for easier pin 4 and platform 3 removal. Identical platforms 3 can be used on two sides of the pedal to save cost. Platforms 3 can be a part of a body 1, where the platforms 3 and body 1 are manufactured as a continuous part. Platforms 3 can comprise a first barrier portion 5, a second barrier portion 6, and a third barrier portion 7. A first barrier portion 5 can comprise multiple segments that when combined help impede a rider's foot from moving in two or more directions when pressure is applied to the pedal. A second barrier portion 6 can comprise multiple segments that when combined help impede a rider's foot from moving in two or more directions when pressure is applied to the pedal. A third barrier portion 7 can comprise multiple segments that when combined supports a foot to help impede a rider's foot from moving in one or more directions when pressure is applied to the pedal. A first barrier portion 5, second barrier portion 6, and third barrier portion 7 can form a barrier that defines an area where a rider's foot will be most comfortable on the pedal. This barrier can be felt by the rider's foot with little pressure, and can aid the rider in placing the foot by feel in a prescribed anatomical position and in relation to the pedal without the rider looking at the pedal.

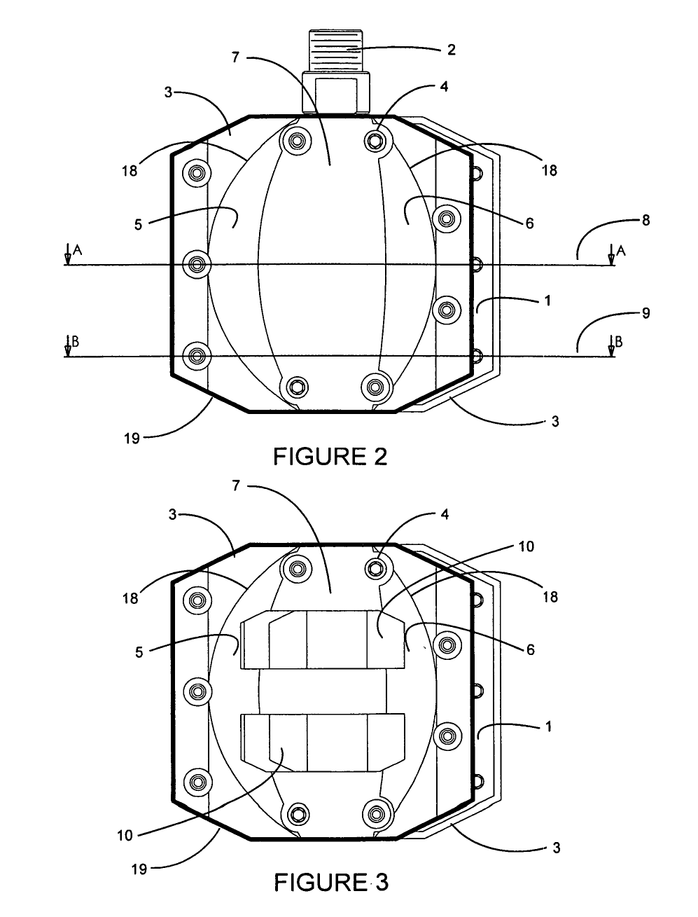

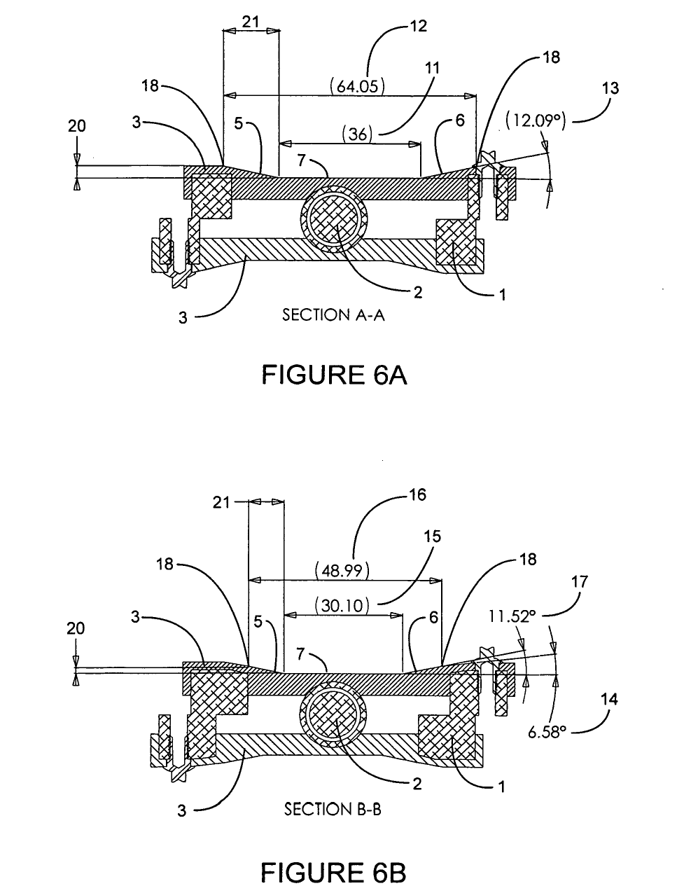

FIG. 2 presents a design for a pedal according to certain embodiments of the current invention via a top view. Shown in FIG. 2 are the following: body (1); spindle (2); platform (3); pin (4); first barrier portion (5); second barrier portion (6); third barrier portion (7); section line A-A (8); section line B-B (9); barrier portion edge (18); outer edge (19). A body 1 acts as a structural support for platforms 3, and provides mounting features for pins 4. The body 1 includes a spindle 2, which is intended to be used to couple the pedal to a bicycle crank arm. The spindle 2 can be a replaceable item, separate from the body 1, or part of the body 1. In designs where a spindle 2 is replaceable, the body 1 can be attached to the spindle 2 so as to allow for independent rotation of the body in relation to the spindle 2. In designs where a spindle 2 is replaceable, the spindle 2 can use a threaded boss to mount to a tapped hole in a bicycle crank arm. In designs where a spindle 2 is part of the body 1, or fixedly attached to the body 1, a spindle 2 can use either a threaded boss or non-threaded boss to mount said spindle 2 to bearings in a bicycle crank arm. The pins 4 use threads that mate with mounting features in the body 1. Pins 4 are arranged so that each pin 4 is removable using a pin removal tool, and so that the pin's 4 tool engagement is protected inside the body 1 during impact. This allows for easier pin 4 and platform 3 removal. Identical platforms 3 can be used on two sides of the pedal to save cost. Platforms 3 can be a part of a body 1, where the platforms 3 and body 1 are manufactured as a continuous part. Platforms 3 can comprise a first barrier portion 5, a second barrier portion 6, and a third barrier portion 7. A first barrier portion 5 can be a surface that curves to help impede a rider's foot from moving in two or more directions when pressure is applied to the pedal. A second barrier portion 6 can be a surface that curves to help impede a rider's foot from moving in two or more directions when pressure is applied to the pedal. A third barrier portion 7 can be a surface that supports a foot to help impede a rider's foot from moving in one or more directions when pressure is applied to the pedal. A first barrier portion 5, second barrier portion 6, and third barrier portion 7 can form a barrier that defines an area where a rider's foot will be most comfortable on the pedal. This barrier can be felt by the rider's foot with little pressure, and can aid the rider in placing the foot by feel in a prescribed anatomical position and in relation to the pedal without the rider looking at the pedal. A barrier portion edge 18 is located at the edge of a first barrier portion 5 or second barrier portion 6. The more defined the barrier portion edge 18 is, and the more easily that a rider can feel the barrier portion edge 18 with his or her foot. A more defined barrier portion edge 18 puts more pressure on the foot surrounding the local area around the barrier portion edge 18. This increased pressure helps the rider to feel increased pressure and better definition of the location of the center of the pedal but can be less comfortable on the rider's foot during long term use. A platform 3 has an outer edge 19 when viewed in the top view. The outer perimeter of a platform 3 when viewed in the top view defines the outer edge 19 of the platform. Section line A-A 8 is used to define a sectional view shown in FIG. 6A. Section line A-A 8 is located in the middle of a platform 3, at a mid point between the outer edges of a platform 3 and perpendicular to a spindle 2 rotation axis when the pedal is viewed from the top. Section line B-B 9 is used to define a sectional view shown in FIG. 6A. Section line B-B 9 is located in the middle of a platform 3, at a point between the outer edges of a platform 3, perpendicular to a spindle 2 rotation axis, parallel to and offset from section line A-A 8 when the pedal is viewed from the top.

FIG. 3 presents a design for a pedal according to certain embodiments of the current invention via a top view. Shown in FIG. 3 are the following: body (1); spindle (2); platform (3); pin (4); first barrier portion (5); second barrier portion (6); third barrier portion (7); hole (10); barrier portion edge (18); outer edge (19). A body 1 acts as a structural support for platforms 3, and provides mounting features for pins 4. The body 1 includes a spindle 2, which is intended to be used to couple the pedal to a bicycle crank arm. The spindle 2 can be a replaceable item, separate from the body 1, or part of the body 1. In designs where a spindle 2 is replaceable, the body 1 can be attached to the spindle 2 so as to allow for independent rotation of the body in relation to the spindle 2. In designs where a spindle 2 is replaceable, the spindle 2 can use a threaded boss to mount to a tapped hole in a bicycle crank arm. In designs where a spindle 2 is part of the body 1, or fixedly attached to the body 1, a spindle 2 can use either a threaded boss or non-threaded boss to mount said spindle 2 to bearings in a bicycle crank arm. The pins 4 use threads that mate with mounting features in the body 1. Pins 4 are arranged so that each pin 4 is removable using a pin removal tool, and so that the pin's 4 tool engagement is protected inside the body 1 during impact. This allows for easier pin 4 and platform 3 removal. Identical platforms 3 can be used on two sides of the pedal to save cost. Platforms 3 can be a part of a body 1, where the platforms 3 and body 1 are manufactured as a continuous part. Platforms 3 can comprise a first barrier portion 5, a second barrier portion 6, and a third barrier portion 7. A first barrier portion 5 can be a surface that curves to help impede a rider's foot from moving in two or more directions when pressure is applied to the pedal. A second barrier portion 6 can be a surface that curves to help impede a rider's foot from moving in two or more directions when pressure is applied to the pedal. A third barrier portion 7 can be a surface that supports a foot to help impede a rider's foot from moving in one or more directions when pressure is applied to the pedal. A first barrier portion 5, second barrier portion 6, and third barrier portion 7 can form a barrier that defines an area where a rider's foot will be most comfortable on the pedal. This barrier can be felt by the rider's foot with little pressure, and can aid the rider in placing the foot by feel in a prescribed anatomical position and in relation to the pedal without the rider looking at the pedal. A barrier portion edge 18 is located at the edge of a first barrier portion 5 or second barrier portion 6. The more defined the barrier portion edge 18 is, and the more easily that a rider can feel the barrier portion edge 18 with his or her foot. A more defined barrier portion edge 18 puts more pressure on the foot surrounding the local area around the barrier portion edge 18. This increased pressure helps the rider to feel increased pressure and better definition of the location of the center of the pedal but can be less comfortable on the rider's foot during long term use. A platform 3 has an outer edge 19 when viewed in the top view. The outer perimeter of a platform 3 when viewed in the top view defines the outer edge 19 of the platform. A hole 10 or holes 10 can perforate the platform 3 to allow clearance for mud, rocks, or other debris. A hole 10 or holes 10 can also be used to make a pedal lighter in weight.

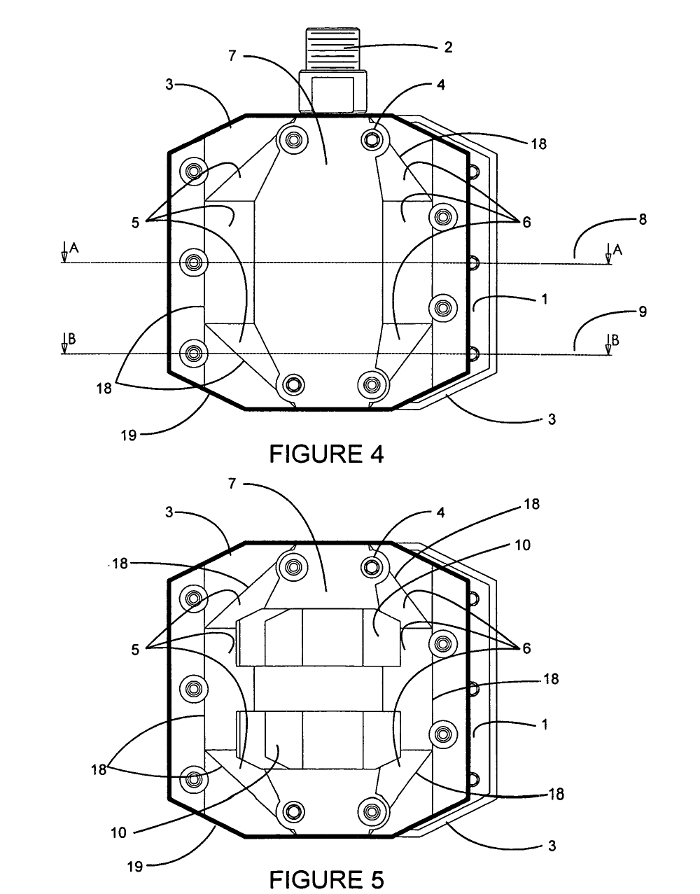

FIG. 4 presents a design for a pedal according to certain embodiments of the current invention via a top view. Shown in FIG. 4 are the following: body (1); spindle (2); platform (3); pin (4); first barrier portion (5); second barrier portion (6); third barrier portion (7); section line A-A (8); section line B-B (9); barrier-portion edge (18); outer edge (19). A body 1 acts as a structural support for platforms 3, and provides mounting features for pins 4. The body 1 includes a spindle 2, which is intended to be used to couple the pedal to a bicycle crank arm. The spindle 2 can be a replaceable item, separate from the body 1, or part of the body 1. In designs where a spindle 2 is replaceable, the body 1 can be attached to the spindle 2 so as to allow for independent rotation of the body in relation to the spindle 2. In designs where a spindle 2 is replaceable, the spindle 2 can use a threaded boss to mount to a tapped hole in a bicycle crank arm. In designs where a spindle 2 is part of the body 1, or fixedly attached to the body 1, a spindle 2 can use either a threaded boss or non-threaded boss to mount said spindle 2 to bearings in a bicycle crank arm. The pins 4 use threads that mate with mounting features in the body 1. Pins 4 are arranged so that each pin 4 is removable using a pin removal tool, and so that the pin's 4 tool engagement is protected inside the body 1 during impact. This allows for easier pin 4 and platform 3 removal. Identical platforms 3 can be used on two sides of the pedal to save cost. Platforms 3 can be a part of a body 1, where the platforms 3 and body 1 are manufactured as a continuous part. Platforms 3 can comprise a first barrier portion 5, a second barrier portion 6, and a third barrier portion 7. A first barrier portion 5 can comprise multiple segments that when combined help impede a rider's foot from moving in two or more directions when pressure is applied to the pedal. A second barrier portion 6 can comprise multiple segments that when combined help impede a rider's foot from moving in two or more directions when pressure is applied to the pedal. A third barrier portion 7 can comprise multiple segments that when combined supports a foot to help impede a rider's foot from moving in one or more directions when pressure is applied to the pedal. A first barrier portion 5, second barrier portion 6, and third barrier portion 7 can form a barrier that defines an area where a rider's foot will be most comfortable on the pedal. This barrier can be felt by the rider's foot with little pressure, and can aid the rider in placing the foot by feel in a prescribed anatomical position and in relation to the pedal without the rider looking at the pedal. A barrier portion edge 18 is located at the edge of a first barrier portion 5 or second barrier portion 6. The more defined the barrier portion edge 18 is, and the more easily that a rider can feel the barrier portion edge 18 with his or her foot. A more defined barrier portion edge 18 puts more pressure on the foot surrounding the local area around the barrier portion edge 18. This increased pressure helps the rider to feel increased pressure and better definition of the location of the center of the pedal but can be less comfortable on the rider's foot during long term use. A platform 3 has an outer edge 19 when viewed in the top view. The outer perimeter of a platform 3 when viewed in the top view defines the outer edge 19 of the platform. Section line A-A 8 is used to define a sectional view shown in FIG. 6A. Section line A-A 8 is located between the outer edges of a platform 3 and perpendicular to a spindle 2 rotation axis when the pedal is viewed from the top. Section line B-B 9 is used to define a sectional view shown in FIG. 6B. Section line B-B 9 is located between the outer edges of a platform 3, perpendicular to a spindle 2 rotation axis, parallel to and offset from section line A-A 8 when the pedal is viewed from the top.

FIG. 5 presents a design for a pedal according to certain embodiments of the current invention via a top view. Shown in FIG. 5 are the following: body (1); spindle (2); platform (3); pin (4); first barrier portion (5); second barrier portion (6); third barrier portion (7); hole (10); barrier portion edge (18); outer edge (19). A body 1 acts as a structural support for platforms 3, and provides mounting features for pins 4. The body 1 includes a spindle 2, which is intended to be used to couple the pedal to a bicycle crank arm. The spindle 2 can be a replaceable item, separate from the body 1, or part of the body 1. In designs where a spindle 2 is replaceable, the body 1 can be attached to the spindle 2 so as to allow for independent rotation of the body in relation to the spindle 2. In designs where a spindle 2 is replaceable, the spindle 2 can use a threaded boss to mount to a tapped hole in a bicycle crank arm. In designs where a spindle 2 is part of the body 1, or fixedly attached to the body 1, a spindle 2 can use either a threaded boss or non-threaded boss to mount said spindle 2 to bearings in a bicycle crank arm. The pins 4 use threads that mate with mounting features in the body 1. Pins 4 are arranged so that each pin 4 is removable using a pin removal tool, and so that the pin's 4 tool engagement is protected inside the body 1 during impact. This allows for easier pin 4 and platform 3 removal. Identical platforms 3 can be used on two sides of the pedal to save cost. Platforms 3 can be a part of a body 1, where the platforms 3 and body 1 are manufactured as a continuous part. Platforms 3 can comprise a first barrier portion 5, a second barrier portion 6, and a third barrier portion 7. A first barrier portion 5 can comprise multiple segments that when combined help impede a rider's foot from moving in two or more directions when pressure is applied to the pedal. A second barrier portion 6 can comprise multiple segments that when combined help impede a rider's foot from moving in two or more directions when pressure is applied to the pedal. A third barrier portion 7 can comprise multiple segments that when combined supports a foot to help impede a rider's foot from moving in one or more directions when pressure is applied to the pedal. A first barrier portion 5, second barrier portion 6, and third barrier portion 7 can form a barrier that defines an area where a rider's foot will be most comfortable on the pedal. This barrier can be felt by the rider's foot with little pressure, and can aid the rider in placing the foot by feel in a prescribed anatomical position and in relation to the pedal without the rider looking at the pedal. A barrier portion edge 18 is located at the edge of a first barrier portion 5 or second barrier portion 6. The more defined the barrier portion edge 18 is, and the more easily that a rider can feel the barrier portion edge 18 with his or her foot. A more defined barrier portion edge 18 puts more pressure on the foot surrounding the local area around the barrier portion edge 18. This increased pressure helps the rider to feel increased pressure and better definition of the location of the center of the pedal but can be less comfortable on the rider's foot during long term use. A platform 3 has an outer edge 19 when viewed in the top view. The outer perimeter of a platform 3 when viewed in the top view defines the outer edge 19 of the platform. A hole 10 or holes 10 can perforate the platform 3 to allow clearance for mud, rocks, or other debris. A hole 10 or holes 10 can also be used to make a pedal lighter in weight.

FIG. 6A presents a design for a pedal according to certain embodiments of the current invention via a sectional view A-A. Shown in FIG. 6A are the following: body (1); spindle (2); platform (3); first barrier portion (5); second barrier portion (6); third barrier portion (7); lower footbed distance (11); upper footbed distance (12); barrier portion angle (13); barrier portion edge (18); barrier portion height (20); barrier portion width (21). Section line A-A shown in FIGS. 2 and 4 is used to define the sectional view A-A shown in FIG. 6A. A body 1 acts as a structural support for platforms 3, and provides mounting features for pins 4. The body 1 includes a spindle 2, which is intended to be used to couple the pedal to a bicycle crank arm. The spindle 2 can be a replaceable item, separate from the body 1, or part of the body 1. In designs where a spindle 2 is replaceable, the body 1 can be attached to the spindle 2 so as to allow for independent rotation of the body in relation to the spindle 2. In designs where a spindle 2 is replaceable, the spindle 2 can use a threaded boss to mount to a tapped hole in a bicycle crank arm. In designs where a spindle 2 is part of the body 1, or fixedly attached to the body 1, a spindle 2 can use either a threaded boss or non-threaded boss to mount said spindle 2 to bearings in a bicycle crank arm. The pins 4 use threads that mate with mounting features in the body 1. Pins 4 are arranged so that each pin 4 is removable using a pin removal tool, and so that the pin's 4 tool engagement is protected inside the body 1 during impact. This allows for easier pin 4 and platform 3 removal. Identical platforms 3 can be used on two sides of the pedal to save cost. Platforms 3 can be a part of a body 1, where the platforms 3 and body 1 are manufactured as a continuous part. Platforms 3 can comprise a first barrier portion 5, a second barrier portion 6, and a third barrier portion 7. A first barrier portion 5 can comprise multiple segments that when combined help impede a rider's foot from moving in two or more directions when pressure is applied to the pedal. A second barrier portion 6 can comprise multiple segments that when combined help impede a rider's foot from moving in two or more directions when pressure is applied to the pedal. A third barrier portion 7 can comprise multiple segments that when combined supports a foot to help impede a rider's foot from moving in one or more directions when pressure is applied to the pedal. A first barrier portion 5, second barrier portion 6, and third barrier portion 7 can form a barrier that defines an area where a rider's foot will be most comfortable on the pedal. This barrier can be felt by the rider's foot with little pressure, and can aid the rider in placing the foot by feel in a prescribed anatomical position and in relation to the pedal without the rider looking at the pedal. A barrier portion edge 18 is located at the edge of a first barrier portion 5 or second barrier portion 6. A first barrier portion 5, or second barrier portion 6, can have one or more barrier portion edges 18. A barrier portion edge 18 can in certain embodiments be located at the perimeter of a barrier portion. A barrier portion edge 18 can in certain embodiments be located at the upper or lower bound of a barrier portion. The more defined the barrier portion edge 18 is, and the more easily that a rider can feel the barrier portion edge 18 with his or her foot. A more defined barrier portion edge 18 puts more pressure on the foot surrounding the local area around the barrier portion edge 18. This increased pressure helps the rider to feel increased pressure and better definition of the location of the center of the pedal but can be less comfortable on the rider's foot during long term use. A lower footbed distance 11, can be a measured distance of a third barrier portion 7. An upper footbed distance 12 can be measured between a first barrier portion 5 and second barrier portion 6 at a distance further away from a spindle 2 than a lower footbed distance 11. An upper footbed distance 12 can be measured between a barrier portion edge 18 of a first barrier portion 5 and barrier portion edge 18 of a second barrier portion 6 at a distance further away from a spindle 2 than a lower footbed distance 11. An upper footbed distance 6 can be greater than, equal to, or smaller than a lower footbed distance 5. A barrier portion height 20 can be measured vertically between a barrier portion edge 18 at the upper bound of a barrier portion, and a barrier portion edge 18 at the lower bound of a barrier portion. A barrier portion width 21 can be measured horizontally between a barrier portion edge 18 at the upper bound of a barrier portion, and a barrier portion edge 18 at the lower bound of a barrier portion. A barrier portion angle 13 is measured as the angle between a third barrier portion 7 and a first barrier portion 5 or second barrier portion 6 at a section A-A. The greater a barrier portion angle 13, the less supportive the platform 3 will be for the rider's foot when pressure is applied to the platform.

FIG. 6B presents a design for a pedal according to certain embodiments of the current invention via a sectional view B-B. Shown in FIG. 6B are the following: body (1); spindle (2); platform (3); first barrier portion (5); second barrier portion (6); third barrier portion (7); second angle (14); lower footbed distance (15); upper footbed distance (16); barrier portion angle (17); barrier portion edge (18); barrier portion height (20); barrier portion width (21). Section line B-B shown in FIGS. 2 and 4 is used to define the sectional view B-B shown in FIG. 6A. A body 1 acts as a structural support for platforms 3, and provides mounting features for pins 4. The body 1 includes a spindle 2, which is intended to be used to couple the pedal to a bicycle crank arm. The spindle 2 can be a replaceable item, separate from the body 1, or part of the body 1. In designs where a spindle 2 is replaceable, the body 1 can be attached to the spindle 2 so as to allow for independent rotation of the body in relation to the spindle 2. In designs where a spindle 2 is replaceable, the spindle 2 can use a threaded boss to mount to a tapped hole in a bicycle crank arm. In designs where a spindle 2 is part of the body 1, or fixedly attached to the body 1, a spindle 2 can use either a threaded boss or non-threaded boss to mount said spindle 2 to bearings in a bicycle crank arm. The pins 4 use threads that mate with mounting features in the body 1. Pins 4 are arranged so that each pin 4 is removable using a pin removal tool, and so that the pin's 4 tool engagement is protected inside the body 1 during impact. This allows for easier pin 4 and platform 3 removal. Identical platforms 3 can be used on two sides of the pedal to save cost. Platforms 3 can be a part of a body 1, where the platforms 3 and body 1 are manufactured as a continuous part. Platforms 3 can comprise a first barrier portion 5, a second barrier portion 6, and a third barrier portion 7. A first barrier portion 5 can comprise multiple segments that when combined help impede a rider's foot from moving in two or more directions when pressure is applied to the pedal. A second barrier portion 6 can comprise multiple segments that when combined help impede a rider's foot from moving in two or more directions when pressure is applied to the pedal. A third barrier portion 7 can comprise multiple segments that when combined supports a foot to help impede a rider's foot from moving in one or more directions when pressure is applied to the pedal. A first barrier portion 5, second barrier portion 6, and third barrier portion 7 can form a barrier that defines an area where a rider's foot will be most comfortable on the pedal. This barrier can be felt by the rider's foot with little pressure, and can aid the rider in placing the foot by feel in a prescribed anatomical position and in relation to the pedal without the rider looking at the pedal. A barrier portion edge 18 is located at the edge of a first barrier portion 5 or second barrier portion 6. A first barrier portion 5, or second barrier portion 6, can have one or more barrier portion edges 18. A barrier portion edge 18 can in certain embodiments be located at the perimeter of a barrier portion. A barrier portion edge 18 can in certain embodiments be located at the upper or lower bound of a barrier portion. The more defined the barrier portion edge 18 is, and the more easily that a rider can feel the barrier portion edge 18 with his or her foot. A more defined barrier portion edge 18 puts more pressure on the foot surrounding the local area around the barrier portion edge 18. This increased pressure helps the rider to feel increased pressure and better definition of the location of the center of the pedal but can be less comfortable on the rider's foot during long term use. An outer lower footbed distance 15, can be a measured distance of a third barrier portion 7. An outer upper footbed distance 16 can be measured between a first barrier portion 5 and second barrier portion 6 at a distance further away from a spindle 2 than an outer lower footbed distance 15. An outer upper footbed distance 16 can be measured between a barrier portion edge 18 of a first barrier portion 5 and barrier portion edge 18 of a second barrier portion 6 at a distance further away from a spindle 2 than an outer lower footbed distance 15. An outer upper footbed distance 16 can be greater than, equal to, or smaller than an outer lower footbed distance 15. An outer upper footbed distance 16 measured at section B-B can have a lesser value than an outer lower footbed distance15. This allows the first barrier portion 5, and second barrier portion 6 to support the ball of the rider's foot from four or more directions combined. An outer barrier portion angle 17 is measured as the angle between a third barrier portion 7 and a first barrier portion 5 or second barrier portion 6 at a section A-A. The greater an outer barrier portion angle 17, the less supportive the platform 3 will be for the rider's foot when pressure is applied to the platform. A second angle 14 extends from an edge furthest from the spindle 2 in a top view, of the first barrier portion 5 or second barrier portion 6. A barrier portion height 20 can be measured vertically between a barrier portion edge 18 at the upper bound of a barrier portion, and a barrier portion edge 18 at the lower bound of a barrier portion. A barrier portion width 21 can be measured horizontally between a barrier portion edge 18 at the upper bound of a barrier portion, and a barrier portion edge 18 at the lower bound of a barrier portion.

### 5.2 Bodies of Pedals of the Invention

A body of a pedal of the current invention, in certain embodiments, comprises a platform, platforms, locating feature, mounting feature, platform mounting feature, threaded hole, hole, boss, tab, snap fit feature, spindle receptacle, bore, bearing bore, bushing bore, pin, pins, spikes, traction spikes, clipless pedal spindle, spindle, removable spindle, pin removal tool clearance, thread locking feature, clipless pedal mechanism, and/or a foot platform, or any combination of any or less than all of these. A body of a pedal of the current invention can be designed to mate with a platform so that the platform and body combine to form a pedal. A body can be manufactured through machining, forging, casting, extrusion, or other methods. A machined, cast, or forged body can in certain embodiments have a structure that defines a perimeter with near vertical walls that act as the structure of the body. An extruded body in can certain embodiments have a structure that is made up of horizontal beams that are machined from an extrusion that is extruded in a direction axial to a pedal spindle mounting axis. A body can include body mounting features which are intended to be used to secure a platform to a body through a fastened connection. A fastened connection could include a bolted, threaded, riveted, or other type of connection. Locating features can in certain embodiments be part of a body design, where the locating features in the body mate with locating features in a platform so as to transfer impact force to the body from the platform. A locating feature can include a boss, tab, slot, hole, or other feature that constrains a platform in any direction in relationship to a body. In certain preferred embodiments, a pedal is thin and more preferably a pedal is as thin as possible, so as to allow the rider's foot to get as close as possible to a pedal rotation axis. To support this, a pedal in certain embodiments can be constructed from a metal, a light metal, an alloy, aluminum, steel, titanium, and/or magnesium to allow for the thinnest structure around the spindle, and to provide a high strength mounting surface for a platform.

### 5.3 Spindles of Pedals of the Invention

A spindle of a pedal of the current invention, in certain embodiments, comprises a bushing surface, a wear surface, a bearing mounting surface, a bearing race, a bushing race, an axial location feature, a wrench flat, threads, a threaded boss, a mounting boss, a crank arm interface, a clipless pedal locating feature, and/or a clipless pedal mechanism locating feature, or any combination of any or less than all of these. In certain other embodiments, a spindle of a pedal of the invention is made of a metal, a light metal, an alloy, a steel, aluminum, titanium and/or magnesium.

### 5.4 Platforms of Pedals of the Invention

A platform of a pedal of the current invention, in certain embodiments, comprises a body, foot surface, platform surface, foot support, barrier portion, first barrier portion, second barrier portion, third barrier portion, anatomical foot support, lower footbed distance, upper footbed distance, barrier portion angle, second angle, forward barrier portion, rearward barrier portion, inner barrier portion, outer barrier portion, first concave, second concave, front view concave, side view concave, upper surface, lower surface, mounting boss, locating boss, mounting hole, locating hole, mounting feature, locating feature, platform mounting feature, pin, molded pin, molded traction pin, traction surface, textured surface, thread locking feature, compressible surface, snap together feature, front platform, rear platform, upper platform, lower platform, pin removal tool clearance, and/or an end cap cam surface, or any combination of any or less than all of these. In certain embodiments, a platform or platforms and a body can be combined into one part. In certain embodiments, a platform can be secured to a body by a pin. A platform can locate to a body through a variety of mechanical devices, with the most common being a threaded fastener. A platform of a pedal of the current invention can be designed to mate with a body or another platform so that the platform and body combine to form a pedal. A platform can be designed to be used with clipless type or non-clipless type shoes. Platforms designed for use with clipless type shoes can in certain embodiments use fewer traction pins, and can be designed to provide a smaller area for the shoe to contact. Platforms designed for use with non-clipless type shoes can in certain embodiments use more traction pins, and can be designed to provide a larger area for the shoe to contact. Platforms can be designed to feature complex surfaces which can provide greater comfort to the user. A concave surface or barrier portion which allows the platform to cradle around the ball of the foot can give the rider a feel of where his or her foot is in relationship to the pedal. This can assist a rider to place the foot accurately on the pedal during difficult riding conditions. Multiple concave surfaces or barrier portions next to a flat surface can allow the rider to feel a raised surface surrounding a flat surface so that the rider can feel where his or her foot is in relationship to the pedal in both front to back and side to side motions. The top view of a platform, in certain embodiments, can be viewed where the line of sight is on an axis perpendicular to a third barrier portion. The top view of a platform, in certain embodiments, can be viewed where the line of sight is on an axis perpendicular to a third barrier portion, and coincident with a pedal spindle rotation axis. The top view of a platform, in certain embodiments, can be viewed where the line of sight is on an axis perpendicular to a plane which supports the top a platform. Platforms have outer edges when viewed in the top view. The outer perimeter of a platform when viewed in the top view defines the outer edges of the platform. With the platform sitting on a Cartesian plane in the top view, with the pedal spindle rotation axis coincident with the X-Axis, and with a point at the Y axis halfway between the farthest right and left outer edges, platform outer edges can be measured at the extremities of the platform's X and Y axes. A removable platform can in certain embodiments be constructed by injection molding. Injection molding of the platform can be a cost effective way to built complex platform shapes including concaves, mounting features, locating features, or snap features which can be used to secure, locate, or attach a platform to another platform, a spindle, a body, or a pin. Injection molding is also beneficial because different colors can be easily built into platforms, which can increase visibility to help keep riders on the street safe from vehicle operators. Injection molding thermoplastic resins such as nylon and polycarbonate can be used to manufacture platforms that can exhibit a higher toughness to weight ratio than a metal platform. Removable thermoplastic resin platforms can be advantageous to reduce the effect of impact on the pedal. High impact resistance of the thermoplastic resin is well suited for the impact resistance and abrasion requirement of a pedal body. Because thermoplastic is the same color throughout its volume, as a thermoplastic removable platform is worn away by use, the color of the platform does not get worn away, contributing to the appearance of the pedal. A cam surface that mates with an opposing surface on a pedal cap can be designed into a platform to allow easy removal of a pedal cap, where a pedal cap is designed to seal bearings or bushings in the body from contamination. A platform of the invention in certain embodiments can be attached to a body so that a platform is constrained by the head of a pin in relation to the body. In certain embodiments, a platform can be designed to be most compatible with shoes of a type and/or size of interest. A larger platform could be designed for use with a larger shoe. A smaller platform could be designed for use with a smaller shoe. In certain embodiments, a platform of a pedal of the invention is designed to favor a position that is lower (closer to the ground) than another platform of the pedal, preferably so that one side of the pedal is more favored to be up and therefore better accessible to the rider.

### 5.5 Pins of Pedals of the Invention

A pin of a pedal of the current invention, in certain embodiments, comprises a thread, rivet, locking feature, head, shoulder, tool engagement, traction spike, smooth traction spike, sharp traction spike, hex key receptacle, screwdriver receptacle, nut driver boss, hex shaped outer shape, and/or a round outer shape, or any combination of any or less than all of these. Pins of pedals of the current invention can be used to locate, secure, and or mount platforms to bodies. A pin can include a shoulder that allows the user to thread a pin into a body and apply torque so that the platform is not crushed by the head of the pin. A shoulder and or a thread of a pin can be used in certain embodiments to locate a platform so that the platform is constrained in directions forward and sideways in relationship to a body. A head of a pin can locate a platform so that the platform is constrained in a direction away from the body. A shoulder can be part of a body in some embodiments, where a pin's head is responsible for location of a platform in a direction away from a body.

### 5.6 Barrier Portions of Pedals of the Invention

A barrier portion of a pedal of the current invention, in certain embodiments, comprises a foot surface, platform surface, foot support, barrier portion, first barrier portion, second barrier portion, third barrier portion, fourth barrier portion, multiple barrier portions, anatomical foot support, lower footbed distance, upper footbed distance, barrier portion angle, forward barrier portion, rearward barrier portion, inner barrier portion, outer barrier portion, first concave, second concave, front view concave, side view concave, upper surface, and/or a lower surface, or any combination of any or less than all of these. Multiple barrier portions can be used to help impede a rider's foot from moving in two or more directions when pressure is applied to the pedal. A first barrier portion can be a surface that curves or comprise multiple segments or multiple surfaces that when combined help impede a rider's foot from moving in two or more directions when pressure is applied to the pedal. A second barrier portion can be a surface that curves or comprise multiple segments or multiple surfaces that when combined help impede a rider's foot from moving in two or more directions when pressure is applied to the pedal. A third barrier portion can be a flat or curved surface, or comprise multiple segments or multiple surfaces that when combined supports a foot to help impede a rider's foot from moving in one or more directions when pressure is applied to the pedal. A fourth barrier portion can be a flat or curved surface, or comprise multiple segments or multiple surfaces that when combined supports a foot to help impede a rider's foot from moving in one or more directions when pressure is applied to the pedal. Multiple barrier portions can comprise multiple segments or multiple surfaces that when combined supports a foot to help impede a rider's foot from moving in one or more directions when pressure is applied to the pedal. A barrier portion can be designed to be used with clipless type or non-clipless type shoes. Barrier portions designed for use with clipless type shoes can in certain embodiments can be designed to provide a smaller area for the shoe to contact. Barrier portions designed for use with non-clipless type shoes can in certain embodiments can be designed to provide a larger area for the shoe to contact. Barrier portions can be designed to feature complex surfaces which can provide greater comfort to the user. A concave surface which allows a barrier portion to cradle around the ball of the foot can give the rider a feel of where his or her foot is in relationship to the pedal. Multiple concave surfaces or barrier portions next to a flat surface can allow the rider to feel a raised surface surrounding a flat surface so that the rider can feel where his or her foot is in relationship to the pedal in both front to back and side to side motions. A first barrier portion or second barrier portion that is taller or steeper in relation to the third barrier portion can allow for a more defined edge that a rider can feel with his or her foot. A more defined edge puts more pressure on the foot surrounding the local area around the edge. This increased pressure helps the rider to feel increased pressure and better definition of the location of the center of the pedal but can be less comfortable on the rider's foot during long term use. A balance of barrier portion edge pressure and comfort can be attained. A first barrier portion, second barrier portion, and third barrier portion can combine to form a barrier that defines an area where a rider's foot will be most comfortable on the pedal. Barrier portions can combine to position the ball of a rider's foot fore or aft, and side to side in relation to a pedal platform or spindle. A first barrier portion, or second barrier portion, can have one or more barrier portion edges. A barrier portion edge can in certain embodiments be located at the perimeter of a barrier portion. A barrier portion edge can in certain embodiments be located at the upper or lower bound of a barrier portion. A barrier portion height can be measured vertically between a barrier portion edge at the upper bound of a barrier portion, and a barrier portion edge at the lower bound of a barrier portion. A barrier portion height can be measured as 0.2 mm, 0.5 mm, 1 mm, 2 mm, 3 mm, 4 mm, 5 mm, 6 mm, 7 mm, 8 mm, 9 mm, 10 mm, 15 mm, 20 mm, 25 mm, 30 mm, from 0.2 mm to 5 mm, from 0.2 mm to 10 mm, from 0.2 mm to 20 mm, from 0.2 mm to 30 mm. A barrier portion width can be measured horizontally between a barrier portion edge at the upper bound of a barrier portion, and a barrier portion edge at the lower bound of a barrier portion. A barrier portion width can be measured as 0.1 mm 0.2 mm, 0.5 mm, 1 mm, 2 mm, 3 mm, 4 mm, 5 mm, 6 mm, 7 mm, 8 mm, 9 mm, 10 mm, 15 mm, 20 mm, 30 mm, 50 mm, 75 mm, 100 mm, 150 mm. from 0.1 mm to 50 mm, from 0.1 mm to 100 mm, from 0.5 mm to 150 mm. A pedal design, in certain embodiments can position a first barrier portion and a second barrier portion at equal distances from a pedal spindle rotation axis with the intent of centering the ball of a rider's foot over a pedal spindle. A pedal design, in certain embodiments can position a first barrier portion and a second barrier portion at unequal distances from a pedal spindle rotation axis with the intent of centering the ball of a rider's foot forward of a pedal spindle. A pedal design, in certain embodiments can position a first barrier portion and a second barrier portion at unequal distances from a pedal spindle rotation axis with the intent of centering the ball of a rider's foot rearward of a pedal spindle. A barrier portion can be felt by the rider's foot with little pressure, and can aid the rider in placing the foot by feel in a prescribed anatomical position and in relation to the pedal without the rider looking at the pedal. This can assist a rider to place the foot accurately on the pedal during difficult riding conditions.

### 5.7 Section Lines of the Invention

A section line can be used to define a cross section, sectional view, or section view of a pedal of the current invention. A section line defines the location of a plane that cuts through a pedal of the invention in a direction perpendicular to the view that the section line is shown in. A sectional view can be useful to facilitate the measurement of parameters that can be used to define barrier portions of pedals of the current invention. Multiple section lines can be used to define multiple sectional views. Common nomenclature is used to refer to section lines. This common nomenclature can require a drawn section line to include arrows. The arrows show the direction of the line of sight for a sectional view. Each arrow includes a letter, number, or symbol designation used to name the section view. For example, the letter A at each arrow would be called section line A-A. The letter B at each arrow would be called section line B-B. This nomenclature is used to help differentiate multiple section lines used to define sectional views which are used to facilitate multiple measurements to be taken in a pedal. A section line, in certain embodiments can be named, A-A, B-B, C-C, D-D, E-E, F-F, G-G, or any other combination of the two or more recurring numbers, letters, or symbols. Section line A-A of a pedal of the current invention is used to define a sectional view A-A. Section line A-A, in certain embodiments, is located between the outer edges of a platform and perpendicular to a spindle rotation axis when the pedal is viewed from the top. Section line A-A, in certain embodiments, is located between the outer edges of a platform and perpendicular to a spindle rotation axis, offset from the outer edge of the pedal closest to the pedal spindle threads when the pedal is viewed from the top. Section line A-A, in certain embodiments, is located between the outer edges of a platform and perpendicular to a spindle rotation axis, offset from the outer edge of the pedal closest to the pedal spindle threads by from 1 mm to 10 mm, 1 mm to 20 mm, 1 mm to 30 mm, 1 mm to 40 mm, 1 mm to 50 mm, 1 mm to 60 mm, 1 mm to 70 mm, 1 mm to 100 mm, when the pedal is viewed from the top. Section line B-B of a pedal of the current invention is used to define a sectional view B-B. Section line B-B is located between the outer edges of a platform, perpendicular to a spindle rotation axis, parallel to and offset from section line A-A when the pedal is viewed from the top. Section line B-B, in certain embodiments, is located between the outer edges of a platform and perpendicular to a spindle rotation axis, offset from the outer edge of the pedal closest to the pedal spindle threads by from 1 mm to 10 mm, 1 mm to 20 mm, 1 mm to 30 mm, 1 mm to 40 mm, 1 mm to 50 mm, 1 mm to 60 mm, 1 mm to 70 mm, 1 mm to 100 mm, when the pedal is viewed from the top. Section line B-B, in certain embodiments, is located between the outer edges of a platform and perpendicular to a spindle rotation axis, offset from section line A-A by from 1 mm to 10 mm, 1 mm to 20 mm, 1 mm to 30 mm, 1 mm to 40 mm, 1 mm to 50 mm, 1 mm to 60 mm, 1 mm to 70 mm, 1 mm to 100 mm, when the pedal is viewed from the top.

### 5.8 Lower and Upper Footbed Distances of Pedals of the Invention

An upper footbed distance or a lower footbed distance of the current invention, in certain embodiments, comprises a lower footbed distance, an upper footbed distance, an outer lower footbed distance, an outer upper footbed distance, a measurement, distance, length, horizontal distance, vertical distance, and/or a aligned distance, or any combination of any or less than all of these. In certain preferred embodiments, a lower footbed distance can be less than an upper footbed distance. In certain embodiments, a lower footbed distance can be equal to an upper footbed distance. In certain embodiments, a lower footbed distance can be greater than an upper footbed distance. In certain preferred embodiments, an outer lower footbed distance can be less than an outer upper footbed distance. In certain embodiments, an outer lower footbed distance can be equal to an outer upper footbed distance. In certain embodiments, an outer lower footbed distance can be greater than an outer upper footbed distance. The ratio of upper footbed distance to lower footbed distance can be a useful metric to determine how easily a rider's foot can feel the location of a barrier portion in the fore to aft directions. In certain embodiments, the ratio of upper footbed distance to lower footbed distance is 1:1, 1.1:1, 1.2:1, 1.3:1, 1.4:1, 1.5:1, 1.6:1, 1.7:1, 1.8:1, 1.9:1, 2:1, 2.5:1, 3:1, 4:1, 5:1, 10:1, 20:1, 50:1, 100:1, from 1:1 to 20:1, from 1:1 to 10:1, from 1.1:1 to 5:1, from 1.1:1 to 4:1, from 1.1:1 to 3:1, or from 1.1:1 to 2.5:1. The ratio of upper footbed distance to outer upper footbed distance can be a useful metric to determine how easily a rider's foot can feel the location of a barrier portion in the side to side directions. In certain embodiments, the ratio of upper footbed distance to outer upper footbed distance is 1:1, 1.1:1, 1.2:1, 1.3:1, 1.4:1, 1.5:1, 1.6:1, 1.7:1, 1.8:1, 1.9:1, 2:1, 2.5:1, 3:1, 4:1, 5:1, 10:1, 20:1, 50:1, 100:1, from 1:1 to 20:1, from 1:1 to 10:1, from 1.1:1 to 5:1, from 1.1:1 to 4:1, from 1.1:1 to 3:1, or from 1.1:1 to 2.5:1. The ratio of lower footbed distance to outer lower footbed distance can be a useful metric to determine how easily a rider's foot can feel the location of a barrier portion in the side to side directions. In certain embodiments, the ratio of lower footbed distance to outer lower footbed distance is 1:1, 1.1:1, 1.2:1, 1.3:1, 1.4:1, 1.5:1, 1.6:1, 1.7:1, 1.8:1, 1.9:1, 2:1, 2.5:1, 3:1, 4:1, 5:1, 10:1, 20:1, 50:1, 100:1, from 1:1 to 20:1, from 1:1 to 10:1, from 1.1:1 to 5:1, from 1.1:1 to 4:1, from 1.1:1 to 3:1, or from 1.1:1 to 2.5:1.

### 5.9 Barrier Portion Angels of Pedals of the Invention

A barrier portion angle of a pedal of the current invention, in certain embodiments, comprises a barrier portion angle, an outer barrier portion angle, barrier portion, barrier portion segment, and/or a barrier portion section tangent, or any combination of any or less than all of these. A barrier portion angle is measured at the mid-point of the barrier portion, for example, as illustrated in section view A-A in FIGS. 2, 4 and 6A. An outer barrier portion angle is measured at a point of the barrier portion that is, for example, as illustrated in section view B-B in FIGS. 2, 4 and 6B. A barrier portion angle or outer barrier portion angle can be measured as a straight line surface projected on the section view. A barrier portion angle or outer barrier portion angle can be measured as a tangent line to a curved surface projected on the section view. The value of a barrier portion angle can be a useful metric to determine how easily a rider's foot can feel the location of a barrier portion. The closer a barrier portion angle is to 90 degrees, the more defined the edge of the barrier portion is, and the more easily that a rider can feel the edge with his or her foot. A more defined edge puts more pressure on the foot surrounding the local area around the edge. This increased pressure helps the rider to feel increased pressure and better definition of the location of the center of the pedal but can be less comfortable on the rider's foot during long term use. A balance of barrier portion edge pressure and comfort can be attained by selecting a barrier portion angle during the pedal design process that meets both pedal location perception and rider comfort requirements. The value of a barrier portion angle, in certain embodiments can have a degree measurement of 0.5, 1, 3, 5, 7, 9, 10, 20, 30, 40, 50, 60, 70, 80, 89, 90, from 0.5 to 20, from 0.5 to 50, from 0.5 to 89, from 0.5 to 90.

### 5.10 Barrier Portion Edges of Pedals of the Invention

A barrier portion edge of a pedal of the current invention, in certain embodiments, comprises a, forward edge, rearward edge, fore edge, aft edge, side edge, right edge, left edge, curved edge, concave edge, convex edge, straight edge, and/or an edge segment, or any combination of any or less than all of these. A barrier portion edge is located at the edge of a first barrier portion or second barrier portion. The more defined the barrier portion edge is, the more easily that a rider can feel the barrier portion edge with his or her foot. A more defined barrier portion edge puts more pressure on the foot surrounding the local area around the barrier portion edge. This increased pressure helps the rider to feel increased pressure and better definition of the location of the center of the pedal but can be less comfortable on the rider's foot during long term use. A barrier portion edge can be engineered to be more defined or less defined during a pedal design process by changing the value of the barrier portion angle. A barrier portion angle with a value closer to 0 degrees will result in a less defined barrier portion edge. A barrier portion angle with a value closer to 90 degrees will result in a more defined barrier portion edge. A barrier portion edge can be engineered to be more defined or less defined during a pedal design process by changing the value of the ratio of upper footbed distance to lower footbed distance. A ratio of upper footbed distance closer to 100:1 will result in a less defined barrier portion edge. A ratio of upper footbed distance closer to 1:1 will result in a more defined barrier portion edge. A barrier portion edge can be engineered to be more defined or less defined during a pedal design process by changing the value of the ratio of upper footbed distance to outer upper footbed distance. A ratio of upper footbed distance to outer upper footbed distance closer to 1:1 will result in a less defined barrier portion edge. A ratio of upper footbed distance to outer upper footbed distance closer to 100:1 will result in a more defined barrier portion edge. A barrier portion edge can be engineered to be more defined or less defined during a pedal design process by changing the value of the ratio of lower footbed distance to outer lower footbed distance. A ratio of lower footbed distance to outer lower footbed distance closer to 1:1 will result in a less defined barrier portion edge. A ratio of lower footbed distance to outer lower footbed distance closer to 100:1 will result in a more defined barrier portion edge.

### 5.11 Further Embodiments of the Invention

A body, in certain embodiments, may be comprised of a solid beam, a solid bar, a metal bar, a plastic bar, a composite bar, a tube, a metal tube, welding, MIG welding, TIG welding, laser welding, friction welding, a welded tube, a TIG welded tube, a MIG welded tube, a laser welded tube, a friction welded tube, a monocoque section, a monocoque frame, metal monocoque, TIG welded monocoque, MIG welded monocoque, laser welded monocoque, friction welded monocoque, carbon monocoque, Kevlar monocoque, fiberglass monocoque, composite monocoque, fiberglass, carbon fiber, foam, honeycomb, stress skin, braces, extrusion, extrusions, metal inserts, rivets, screws, castings, forgings, CNC machined parts, machined parts, stamped metal parts, progressive stamped metal parts, tubes or monocoque parts welded to cast parts, tubes or monocoque parts welded to forged parts, tubes or monocoque parts welded to machined parts, tubes or monocoque parts welded to CNC machined parts or forged or cast parts, glue, adhesive, injection molding, and/or plastic, or any combination of any or less than all of these.

A platform, in certain embodiments, may be comprised of a solid beam, a solid bar, a metal bar, a plastic bar, a composite bar, a tube, a metal tube, welding, MIG welding, TIG welding, laser welding, friction welding, a welded tube, a TIG welded tube, a MIG welded tube, a laser welded tube, a friction welded tube, a monocoque section, a monocoque frame, metal monocoque, TIG welded monocoque, MIG welded monocoque, laser welded monocoque, friction welded monocoque, carbon monocoque, Kevlar monocoque, fiberglass monocoque, composite monocoque, fiberglass, carbon fiber, foam, honeycomb, stress skin, braces, extrusion, extrusions, metal inserts, rivets, screws, castings, forgings, CNC machined parts, machined parts, stamped metal parts, progressive stamped metal parts, tubes or monocoque parts welded to cast parts, tubes or monocoque parts welded to forged parts, tubes or monocoque parts welded to machined parts, tubes or monocoque parts welded to CNC machined parts or forged or cast parts, glue, adhesive, injection molding, and/or plastic, or any combination of any or less than all of these.

The present invention is not to be limited in scope by the specific embodiments described herein, which are intended as single illustrations of individual aspects of the invention, and functionally equivalent methods and components are within the scope of the invention. Indeed, various modifications of the invention, in addition to those shown and described herein, will become apparent to those skilled in the art from the foregoing description. Such modifications are intended to fall within the scope of the appended claims. Throughout this application the singular includes the plural and the plural includes the singular, unless indicated otherwise. All numerals for dimensions and angles provided herein include the precise numerals and also the numerals modified through the word “about”. All cited publications, patents, and patent applications are herein incorporated by reference in their entirety.

What is claimed is:

1. A bicycle pedal which comprises a body, a platform, a spindle, a first barrier portion, a second barrier portion, a third barrier portion, a barrier portion angle, and an outer barrier portion angle, wherein said barrier portion angle has a degree measurement between 0.5 and 90.

2. The bicycle pedal of claim 1, wherein said body and platform are combined and manufactured as a single part.

3. The bicycle pedal of claim 1, where said pedal further comprises a pin, wherein said platform is removable, and wherein said platform is constrained to said body by said pin.

4. The bicycle pedal of claim 1, where said first barrier portion comprises one or more of the following: a concave surface, a flat surface, a curved surface, multiple segments, multiple surfaces, wherein said first barrier portion impedes a rider's foot from moving in two or more directions when pressure is applied to the pedal by a foot.

5. A bicycle pedal which comprises a body, a platform, and a pin, a first barrier portion, a second barrier portion, a third barrier portion, a lower footbed distance, a lower outer footbed distance, an upper footbed distance, and an upper outer footbed distance, wherein the ratio of upper footbed distance to lower footbed distance is between 1.1:1 and 100:1.

6. The bicycle pedal of claim 5, wherein the ratio of upper footbed distance to outer upper footbed distance is between 1.1:1 and 100:1.

7. The bicycle pedal of claim 5, wherein the ratio of lower footbed distance to outer lower footbed distance is between 1.1:1 and 100:1.

8. The bicycle pedal of claim 5, wherein said body and platform are combined and manufactured as a single part.

9. The bicycle pedal of claim 5, wherein said platform is removable, and wherein said platform is constrained to said body by said pin.

10. A bicycle pedal which comprises a body, a platform, and a pin, a first barrier portion, a second barrier portion, a third barrier portion, a barrier portion angle, and an outer barrier portion angle, where said third barrier portion comprises a flat surface, and wherein said barrier portion angle has a degree measurement between 0.5 and 90.

11. The bicycle pedal of claim 10, wherein said body and platform are combined and manufactured as a single part.

12. The bicycle pedal of claim 10, where said pedal further comprises a pin, wherein said platform is removable, and wherein said platform is constrained to said body by said pin.

13. The bicycle pedal of claim 10, where said first barrier portion comprises one or more of the following: a concave surface, a flat surface, a curved surface, multiple segments, multiple surfaces, wherein said first barrier portion impedes a rider's foot from moving in two or more directions when pressure is applied to the pedal by a foot.

14. A bicycle pedal which comprises a body, a platform, and a pin, a first barrier portion, a second barrier portion, a third barrier portion, a lower footbed distance, a lower outer footbed distance, an upper footbed distance, and an upper outer footbed distance, where said third barrier portion comprises a flat surface, and wherein the ratio of upper footbed distance to lower footbed distance is between 1.1:1 and 100:1.

15. The bicycle pedal of claim 14, wherein the ratio of upper footbed distance to outer upper footbed distance is between 1.1:1 and 100:1.

16. The bicycle pedal of claim 14, wherein the ratio of lower footbed distance to outer lower footbed distance is between 1.1:1 and 100:1.
